(19) United States
(12) Patent Application Publication
(10) Pub. No.: US 2015/0364817 A1
(43) Pub. Date: Dec. 17, 2015

(54) Antenna system

(71) Applicant: ZTE CORPORATION, Shenzhen, Guangdong (CN)

(72) Inventors: Jinping Ma, Shenzhen (CN); Feifei Sun, Shenzhen (CN); Yang Liu, Shenzhen (CN)

(21) Appl. No.: 14/763,274

(22) PCT Filed: Jul. 24, 2013
(86) PCT No.: PCT/CN2013/079995

§ 371 Date: Jul. 24, 2015

(30) Foreign Application Priority Data
Jan. 28, 2013 (CN) 201320046164.9

(51) Int. Cl. H01Q 1/52

(52) U.S. Cl. CPC H01Q 1/521; H01Q 1/526

(57) ABSTRACT

Disclosed is an antenna system, comprising: more than two antennas and a left-handed material isolation layer. The left-handed material isolation layer is disposed between adjacent two antennas in the more than two antennas in a suspended manner. By using the antenna system provided in the present utility model, a coupling effect between antennas can be weakened through the left-handed material isolation layer, thereby improving the isolation between antennas.

### TECHNICAL FIELD

The disclosure relates to an antenna technology of a terminal, and more particular, to an antenna system provided with left-handed materials.

### BACKGROUND

An antenna is one of the important elements of a wireless communication product, the performance and size of which are directly related to the quality of the wireless communication product. Multi-antenna systems have become the mainstream of the market as higher signal strength is required by communication products. However, interference among a plurality of antennas in the communication products has become a problem to be solved in antenna design.

One of the common antenna design methods is to put a plurality of antennas respectively at two ends of a communication product so as to increase isolation among the plurality of antennas by a spatial distance, thereby reducing interference. However, the spatial distance will increase the size of an antenna system, which is contrary to a development tendency of miniaturization of the antenna system.

### BRIEF DESCRIPTION OF THE DRAWINGS

In view of this, the embodiments of the disclosure are intended to provide an antenna system so that isolation among a plurality of antennas can be increased effectively.

To this end, the embodiments of the disclosure provide the following technical solutions.

An embodiment of the disclosure provides an antenna system. The antenna system includes: more than two antennas and a left-handed material isolation layer, wherein
the left-handed material isolation layer is suspended between two adjacent antennas of the more than two antennas.

According to an embodiment, the left-handed material includes copper or stainless steel.

According to an embodiment, the antenna system further includes: a feed system and a matching circuit configured for each antenna respectively, and the antennas are connected to respective feed systems through respective matching circuits.

According to an embodiment, the antenna system further includes a Printed Circuit Board (PCB); and each antenna and its corresponding feed system and matching circuit are printed in the PCB.

According to an embodiment, the left-handed material isolation layer is composed of metal wires or open metal resonant rings arranged in a shape of an array in the PCB.

According to an embodiment, a resonant frequency of the left-handed material isolation layer is the same as an operating frequency of the more than two antennas.

According to an embodiment, the antennas are monopole antennas or dipole antennas.

According to an embodiment, the left-handed material isolation layer is suspended between the two adjacent antennas in the more than two antennas by locating, without being grounded and fed, the left-handed material isolation layer between the two adjacent antennas.

According to an embodiment, the open metal resonant rings are composed of two concentric circular rings, wherein openings are arranged respectively on an external circular ring and an internal circular ring in the concentric circular rings, and orientation of the opening of the external circular ring is different from that of the internal circular ring.

According to an embodiment, the open metal resonant rings are composed of two concentric circular rings, wherein openings are arranged respectively on an external circular ring and an internal circular ring in the concentric circular rings, and orientation of the opening of the external circular ring is opposite to that of the internal circular ring.

The antenna system provided by the embodiments of the disclosure can weaken a coupling effect between the antennas by suspending a left-handed material isolation layer between two adjacent antennas, thereby improving isolation between the antennas.

### BRIEF DESCRIPTION OF THE DRAWINGS

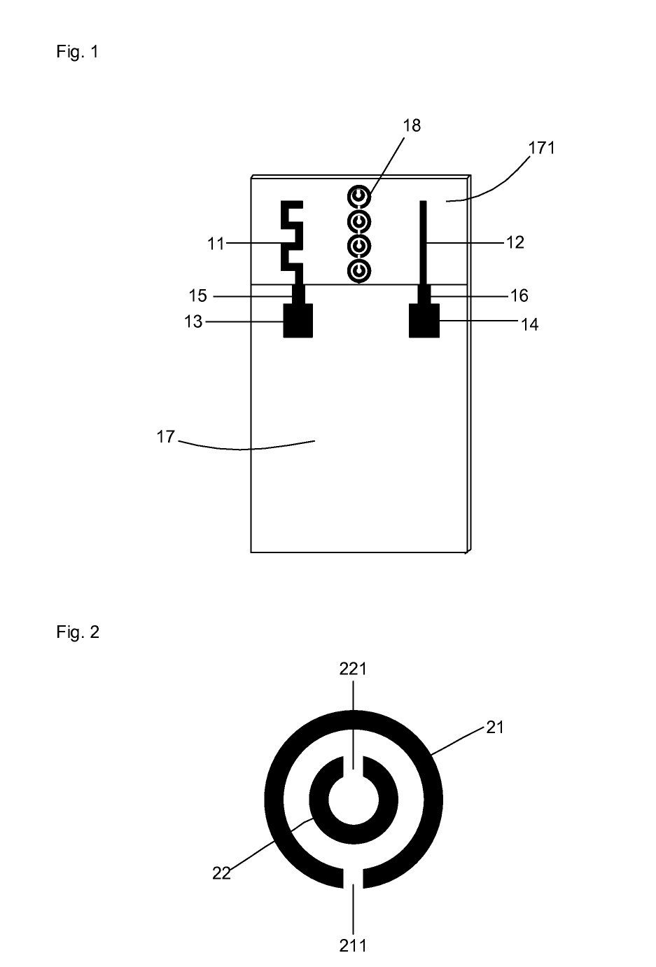

FIG. 1 is a structural diagram of an antenna system according to an embodiment of the disclosure;

FIG. 2 is a structural diagram of a left-handed material isolation layer according to an embodiment of the disclosure; and

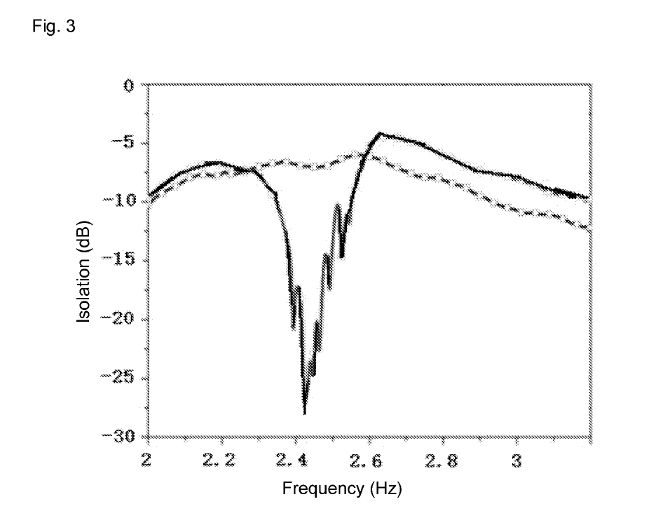

FIG. 3 is a comparison diagram of isolation according to an embodiment of the disclosure.

### DETAILED DESCRIPTION

A further understanding of the nature and advantages of the disclosure may be realized by the following detailed description with reference to the accompanying drawings. The accompanying drawings are only used for reference, but are not intended to limit the disclosure.

An antenna system of the disclosure includes: more than two antennas and a left-handed material isolation layer, wherein the left-handed material isolation layer is arranged between two adjacent said antennas in a suspended manner.

Herein, the suspension refers to that the left-handed material isolation layer is neither grounded nor fed, so as to function as an insulation layer between the antennas.

The antenna system further includes a feed system and a matching circuit respectively configured for each antenna, and the more than two antennas are connected to respective feed systems through respective matching circuits.

The left-handed material isolation layer is configured to function as an insulation layer between the antennas. Specifically, the left-handed material isolation layer functions to change a transmission direction of an electromagnetic wave signal received or transmitted by the antennas, thereby weakening a coupling effect of the electromagnetic wave signals between the antennas.

The antenna system of the embodiments of the disclosure further includes a Printed Circuit Board (PCB). Each antenna and its corresponding feed system and matching circuit are printed in the PCB.

The left-handed material is any of metal materials, such as copper, stainless steel, and so on. The left-handed material isolation layer is composed of metal wires or open metal resonant rings arranged in a shape of an array in the PCB.

Preferably, the antenna system further includes a feed system and a matching circuit configured for each antenna, and the more than two antennas are connected to the respective feed systems through the respective matching circuits.

The antennas may be monopole antennas, dipole antennas and so on.

The feed systems are configured to feed the antennas.

The matching circuits are configured to match and adjust the antennas.

Preferably, the antenna system further includes the PCB in which the antennas, the feed systems and the matching circuits are printed.

In practice, the number of the left-handed isolation layers may be determined according to the number of the antennas so that a left-handed material isolation layer is provided between any two antennas to function as an insulation layer.

### Embodiment 1

When the present embodiment is applied to a data card of a Long Term Evolution (LTE) system having a Wireless Fidelity (WiFi) function, a left-material isolation layer is arranged on the data card so as to function as an insulation layer of the antennas. FIG. 1 is a structural diagram of an antenna system according to an embodiment of the disclosure. As shown in FIG. 1, the antenna system includes: a first antenna 11, a second antenna 12, a first feed system 13 configured for the first antenna 11, a second feed system 14 configured for the second antenna 12, a first matching circuit 15 configured for the first antenna 11, a second matching circuit 16 configured for the second antenna 12, a PCB 17, and a left-handed material isolation layer 18.

The first antenna 11 is connected with the first feed system 13 through the first matching circuit 15. The first antenna 11 is located on the left side of a headroom area 171 on the top of the PCB 17. The first antenna 11 is a monopole zigzag antenna, wherein one end of the first antenna 11 is connected to the first matching circuit 15 and the other end is not connected to any device.

The second antenna 12 is connected with the second feed system 14 through the second matching circuit 16. The second antenna 12 is located on the right side of the headroom area 171 on the top of in the PCB 17. The second antenna 12 is a monopole linear antenna, wherein one end of the second antenna 12 is connected to the second matching circuit 16 and the other end is not connected to any device.

In the above solution, the first antenna 11 and the second antenna 12 are arranged in parallel at two sides of the headroom area 171.

The left-handed material isolation layer 18 is suspended and located between the first antenna 11 and the second antenna 12, in parallel with the first antenna 11 and the second antenna 12. Herein, the suspension refers to that the left-handed material isolation layer is neither grounded nor fed.

A shaped of the left-handed material isolation layer 18 needs to be determined before the left-handed material isolation material 18 is arranged, so that the left-handed material isolation layer 18 has the same frequency or a similar frequency as the first antenna 11 and the second antenna 12, thereby effectively changing a transmission direction of an electromagnetic wave received or transmitted by the first antenna 11 and the second antenna 12 after the left-handed material isolation material 18 is arranged between the first antenna 11 and the second antenna 12, so as to reduce coupling of electromagnetic waves between the first antenna 11 and the second antenna 12 and improve isolation between the two antennas.

### Embodiment 2

FIG. 2 is a structural diagram of a left-handed material isolation layer according to the embodiment. As shown in FIG. 2, the left-handed material isolation layer in the present embodiment is formed of open metal resonant rings as units, wherein each resonant ring unit is composed of two concentric circular rings with different diameters. An opening 211 is arranged on the lower part of an external circular ring 21 so that the external ring is no longer continuous and presents a belt shape. An opening 221 is arranged on the upper part of an internal circular ring 22 so that the internal ring is no longer continuous and presents a belt shape. An opening orientation of the external opening 211 is opposite to that of the internal opening 221, or the opening orientation of the external opening 211 is different from that of the internal opening 221.

Herein, the left-handed material isolation layer has the best isolation effect when the opening orientation of the external opening 211 is opposite to that of the internal opening 221, and the left-handed material isolation layer has a relatively bad isolation effect when the opening orientation of the external opening 211 is different from but not exactly opposite to that of the internal opening 221.

A left-handed material may be formed by arranging the resonant ring units vertically in a shape of an array. A certain number of resonant ring units may be selected according to a practical condition so that a resonant frequency of the left-handed material is the same as or similar to an operating frequency of the antennas, thereby functioning as the left-handed material isolation layer.

### Embodiment 3

In the antenna systems based on the left-handed materials in the first embodiment and the second embodiment, a PCB with an eight-layer plate is selected. The size of the plate of each layer is 22*100 mm². An operating frequency of a first antenna is 2300 MHz to 2400 MHz to support an LTE signal. An operating frequency of a second antenna is 2.4 GHz to support a WiFi signal. A distance between the first antenna and the second antenna is ⅛ of a wavelength.

A left-handed material isolation layer is selected to have four resonant ring units arranged in a shape of an array. A headroom area on the top of each layer of the PCB uses such resonant ring units arranged in a shape of an array. Therefore, eight layers of four resonant ring units arranged in a shape of an array are used as the left-handed material isolation layer in the present embodiment. Preferably, the resonant ring units use a copper material. The diameter of an internal copper ring is 2.12 mm, the diameter of an external copper ring is 4.24 mm, the width of an internal opening is 1.06 mm and the width of an external opening is 1.06 mm. In this way, a resonant frequency of the left-handed material isolation layer is 2.4 GHz, which is the same as the frequencies of the first antenna and the second antenna.

FIG. 3 shows the comparison between a situation in which a left-handed material isolation layer is arranged based on the foregoing parameters and a situation in which a left-handed material isolation layer is not arranged. The dashed line represents a relation between the isolation without a left-handed material isolation layer and the frequency. The isolation is 6 dB when the frequency is 2.4 GHz. The solid line represents a relation between the isolation with a left-handed material isolation layer and the frequency. The isolation is 27 dB when the frequency is 2.4 GHz. The isolation is improved by almost 21 dB when a left-handed material isolation layer is arranged compared with the situation in which a left-handed material isolation layer is not arranged, thereby effectively reducing coupling between two antennas.

What are described above are only preferred embodiments of the disclosure, but are not used for limiting the protection scope of the disclosure.

What is claimed is:

1. An antenna system, comprising: more than two antennas and a left-handed material isolation layer, wherein
the left-handed material isolation layer is suspended between two adjacent antennas of the more than two antennas.

2. The antenna system according to claim 1, wherein the left-handed material comprises: copper or stainless steel.

3. The antenna system according to claim 1, further comprising: a feed system and a matching circuit configured for each antenna respectively, and wherein the antennas are connected to respective feed systems through respective matching circuits.

4. The antenna system according to claim 3, further comprising a Printed Circuit Board (PCB), wherein each antenna and its corresponding feed system and matching circuit are printed in the PCB.

5. The antenna system according to claim 4, wherein the left-handed material isolation layer is composed of metal wires or open metal resonant rings arranged in a shape of an array in the PCB.

6. The antenna system according to claim 1, wherein a resonant frequency of the left-handed material isolation layer is the same as an operating frequency of the more than two antennas.

7. The antenna system according to claim 1, wherein the antennas are monopole antennas or dipole antennas.

8. The antenna system according to claim 1, wherein the left-handed material isolation layer is suspended between the two adjacent antennas in the more than two antennas by locating, without being grounded and fed, the left-handed material isolation layer between the two adjacent antennas.

9. The antenna system according to claim 5, wherein the open metal resonant rings are composed of two concentric circular rings, and wherein openings are arranged respectively on an external circular ring and an internal circular ring in the concentric circular rings, and orientation of the opening on the external circular ring is different from that of the internal circular ring.

10. The antenna system according to claim 5, wherein the open metal resonant rings are composed of two concentric circular rings, and wherein openings are arranged respectively on an external circular ring and an internal circular ring in the concentric circular rings, and orientation of the opening on the external circular ring is opposite to that of the internal circular ring.
